(19) United States
(12) Patent Application Publication
(10) Pub. No.: US 2010/0050845 A1
(43) Pub. Date: Mar. 4, 2010

(54) LOCKING MECHANISM FOR A POSTIONABLE POWER TOOL

(76) Inventor: Aleksander Ipatenco, Belton, SC (US)

Correspondence Address: MICHAEL, BEST & FRIEDRICH LLP, 100 EAST WISCONSIN AVENUE, SUITE 3300, MILWAUKEE, WI, 53202, US

(21) Appl. No.: 12/204,547

(22) Filed: Sep. 4, 2008

(51) Int. Cl. B26D 7/26

(52) U.S. Cl. 83/698.21

(57) ABSTRACT

A magnetic lock for a positionable power tool of the type comprising a workpiece support table moveable relative to a tool base. The magnetic lock comprises a braking surface configured to contact an outer edge of the tool base, and a magnetic device mountable to the workpiece support table adjacent an outer edge of the tool base. The magnetic device is configured to provide a selectively variable force to push the braking surface against the outer edge of the tool base. When the braking surface is pushed against he outer edge of the tool base, the workpiece support table is substantially prevented from moving relative to the tool base.

### TECHNICAL FIELD

This present invention relates to a locking mechanism for a positionable power tool, and in particular, a magnetic lock for a miter saw.

### BACKGROUND

Positionable power tools are well known. In the context of miter saws, such tools generally have a workpiece support table, as well as a saw carriage and blade, which can be rotated through a range of angles relative to a tool base. Typically, a mechanical locking mechanism is provided to lock the position of the workpiece support table at a desired angle. For example, one type of locking mechanism consists of a locking pin connected to the workpiece support table that is engagable in one of a series of corresponding detents or slots located on the tool base. However, with this type of locking mechanism, the angles at which the workpiece support table is capable of locking are limited to the fixed locations of the detents or slots.

In an alternative type of locking mechanism, once a desired angle is obtained, the position of the workpiece support table may be locked relative to the tool base by a cam or threaded device that pushes against and frictionally engages the tool base, thereby preventing further rotation. However, this type of locking mechanism is disadvantageous in that the cam or threaded device necessarily requires large loading forces applied against the workpiece support table to generate sufficient friction to lock the position of the workpiece support table. Such loading forces can cause deflection of the workpiece support table, resulting in inaccurate cuts.

### BRIEF SUMMARY

A magnetic lock for a positionable power tool of the type comprising a workpiece support table moveable relative to a tool base. The magnetic lock comprises a braking surface configured to contact an outer edge of the tool base, and a magnetic device mountable to the workpiece support table adjacent an outer edge of the tool base. The magnetic device is configured to provide a selectively variable force to push the braking surface against the outer edge of the tool base. When the braking surface is pushed against the outer edge of the tool base, the workpiece support table is substantially prevent from moving relative to the tool base.

### BRIEF DESCRIPTION OF THE DRAWINGS

FIG. 1 is a perspective view of a miter saw;

FIG. 2 is a side view of a magnetic lock having a switchable magnet mechanism incorporated into the miter saw of FIG. 1;

FIG. 2a is a side view of the internal magnets housed in the switchable magnet mechanism of FIG. 2, oriented in a position where the switchable magnet mechanism is turned off;

FIG. 2b is a side view of the internal magnets housed in the switchable magnet mechanism of FIG. 2, oriented in a position where the switchable magnet mechanism is turned on;

FIG. 2c is a phantom side view of the magnetic lock of FIG. 2;

FIG. 2d is a cutaway side view of the magnetic lock of FIG. 2 further incorporating a conventional locking mechanism;

FIG. 3 is an alternative embodiment of a magnetic lock having a switchable magnet mechanism incorporated into the miter saw of FIG. 1;

FIG. 4 is a side view of a magnetic lock having an electromagnet incorporated into the miter saw of FIG. 1; and,

FIG. 5 is a side view of a magnetic lock having a permanent magnet incorporated into the miter saw of FIG. 1.

### DESCRIPTION OF THE PREFERRED EMBODIMENTS

The present invention relates to a magnetic lock for a positionable power tool. Although the description of the magnetic lock is explained below in the context of a miter saw, it should be appreciated that the invention is not limited to miter saws. Rather, the invention may be useful in any positionable power tool, and in particular, those where accuracy is desired.

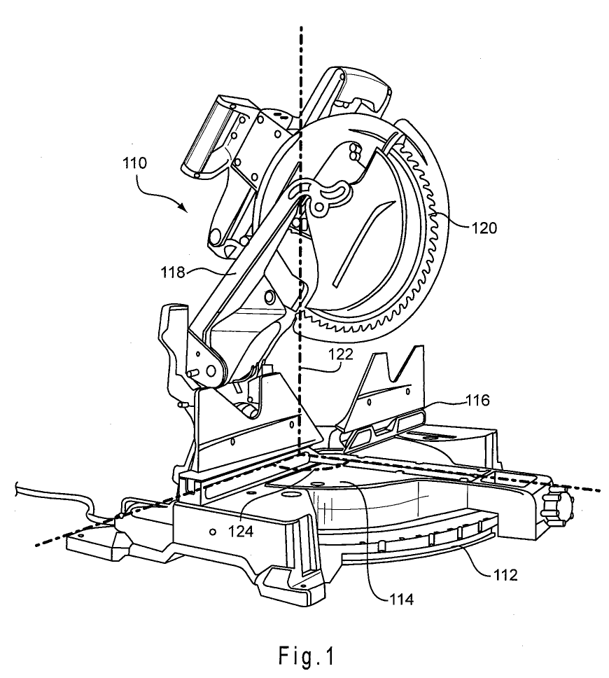

FIG. 1 shows a conventional miter saw 110, which could be a standard chopsaw, a compound miter saw, a sliding compound miter saw, a dual compound miter saw, etc. In general, the miter saw 110 includes a tool base 112, a workpiece support table 114, a fence 116, a saw carriage 118, and a blade 120. The workpiece support table 114, the saw carriage 118, and the blade 120 are rotatable about a central axis 122 relative to the tool base 112 and the fence 116. The workpiece support table 114, the saw carriage 118, and the blade 120 are also interconnected such that rotation of the saw carriage 118 and the blade 120 causes rotation of the workpiece support table 114, and vice-versa. Thus, the miter saw 110 permits a user to adjust a miter cutting angle 124, which can be defined as the angle formed between the fence 116 and the blade 120. The miter saw 110 may also have a conventional micro adjustment lever (not shown), the rotation of which provides for making precise adjustments to the position of the workpiece support table 114 and the miter cutting angle 124.

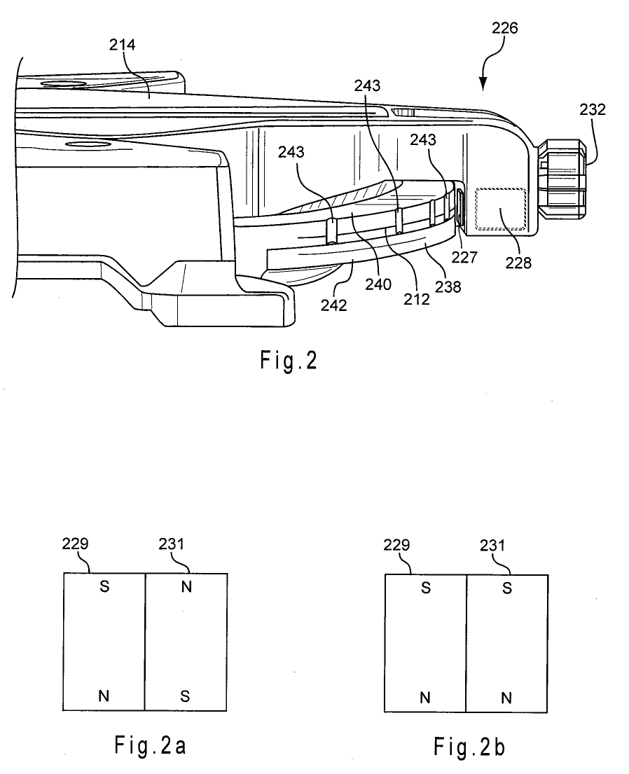

In a first embodiment, a magnetic lock 226 having a switchable magnet mechanism 228 is provided. FIG. 2 shows a side view of the magnetic lock 226 incorporated into the miter saw 110 of FIG. 1. In general, the magnetic lock 226 includes a switchable magnet mechanism 228 slidably mounted in a track 221 (FIG. 2c), and a rotatable knob 232 to selectively activate the magnetic force of the switchable magnet mechanism 228. A biasing means 225 may also be provided to bias the switchable magnet mechanism 228 away from the tool base 212. After the user has selected a desired miter cutting angle, the magnetic lock 226 operates to frictionally resist movement of the workpiece support table 214 relative to a tool base 212. Therefore, the magnetic lock 226 allows a user to lock the position of the workpiece support table 214 at a precise miter cutting angle (not shown) selected by the user.

The switchable magnet mechanism 228 may comprise any commercially available switchable magnet mechanism, such as the Mag-Jig or the MagSqaure, sold under the name MAGSWITCH, available from Magswitch Technology, Inc., of Littletown, Colo., 80120 USA. Descriptions of suitable switchable magnet mechanisms may be found in U.S. Pat. Nos. 6,707,360 and 7,012,495, the entireties of which are hereby incorporated by reference herein. Although the switchable magnet mechanism 228 may be of any size, shape, or strength, a mechanism having cylindrical magnets 20 millimeters in diameter and a holding force of at least 20 pounds is preferable.

Briefly, switchable magnet mechanisms are commercially available devices that allow a magnetic field to essentially be mechanically turned on and off, similar to an electromagnet, but without the need for an electric power supply. Switchable magnet mechanisms generally comprise a pair of magnets contained within a housing. Such magnets are typically of the rare-earth type, such as Neodymium. Typically, one of the magnets is fixed to the housing while the other magnet is rotatable with respect to the housing. A rotatable knob operatively attached to the rotatable magnet may extend from the housing of the switchable magnet mechanism to provide a means of rotating the magnet. Rotation of the knob rotates the rotatable magnet.

A side view of the internal magnets housed within the switchable magnet mechanism is shown in FIG. 2a and FIG. 2b. As shown in FIG. 2a, when the rotatable magnet 231 is rotated to a position where the north pole of the rotatable magnet 231 is aligned with the south pole of the fixed magnet 229, the pair of magnets act as a magnetic shunt, thereby limiting magnetic attraction outside of the housing of the switchable magnet mechanism. In this configuration, the switchable magnet mechanism is turned off. As shown in FIG. 2b, when the knob is rotated an additional 180 degrees, the rotatable magnet 231 is rotated to a position where the north pole of the rotatable magnet 231 is aligned with the north pole of the fixed magnet 229. In this configuration, the switchable magnet mechanism is turned on, the magnetic attraction outside the housing is quite strong, and the switchable magnet mechanism may be firmly affixed to a surface.

The switchable magnet mechanism 228 shown in FIG. 2 selectively provides a magnetic force. A user may turn on or turn off the magnetic force of the switchable magnet mechanism 228 by rotating a knob 232. The knob 232 is operatively connected to the rotatable magnet contained within the housing of the switchable magnet mechanism 228. As shown in FIG. 2, the knob 232 and the switchable magnet mechanism 228 may be axially offset to provide the user with additional clearance between the knob 232 and a table top (not shown). In this configuration, a series of conventional gears (not shown) may be provided to translate the rotational motion of the knob 232 to the rotatable magnet contained within the switchable magnet mechanism 228, thereby allowing a user to rotate the knob 232 to turn on or turn off the switchable magnet mechanism 228. In addition, the gears could be configured to increase or decrease the rotational motion translated from the knob 232 to the rotatable magnet contained within the switchable magnet mechanism 228. Alternatively, the knob 232 may be axially aligned with and directly connected to the switchable magnet mechanism 228. Furthermore, the knob 232 may be provided with a means of providing tactile feedback to the user, such as a series of clicks, or stops, to let the user know when the rotatable magnet within the switchable magnet mechanism 228 has been rotated 180 degrees in a given direction.

When the switchable magnet mechanism 228 is turned off, the switchable magnet mechanism 228 may be disengaged from the tool base 212. The disengaged switchable magnet mechanism 228 may remain within millimeters of the tool base 212, yet avoid contact with the tool base 212, to allow a user to easily position the workpiece support table 214. Alternatively, although the switchable magnet mechanism 228 is turned off, the switchable magnet mechanism 228 may remain in sliding contact with the tool base 212. The sliding contact may result in friction between the tool base 212 and the switchable magnet mechanism 228, but such friction is low and can easily be overcome by the user in adjusting the position of the workpiece support table 214. Regardless of the orientation of the switchable magnet mechanism 228 when turned off, the magnetic lock 226 is unlocked and the workpiece support table 214 is permitted to move.

In contrast, when the switchable magnet mechanism 228 is turned on, a portion of the switchable magnet mechanism 228 firmly engages the tool base 212 under the force of magnetic attraction. This portion may be considered a braking surface 227, which could be part of the housing of the switchable magnet mechanism 228, or alternatively, a separate layer of material connected thereto. The magnetic force operates to greatly increase the frictional resistance between the switchable magnet mechanism 228, or the braking surface 227, and the tool base 212. When the switchable magnet mechanism 228 is turned on, the magnetic lock 226 is locked, and the workpiece support table 214 is substantially prevented from moving relative to the tool base 212. With the position of the workpiece support table 214 locked relative to the tool base 212, a user may proceed with making a cut.

The switchable magnet mechanism 228 may be mounted to the workpiece support table 214 by any suitable means which permits the switchable magnet mechanism 228 to firmly engage the tool base 212 when the magnetic lock 226 is locked, and disengage the tool base 212 when the magnetic lock 226 is unlocked. Importantly, the switchable magnet mechanism 228 should be mounted to the workpiece support table 214 such that, when the magnetic lock 226 is locked, the switchable magnet mechanism 228 does not transfer any significant loading forces to the workpiece support table 214. For example, the switchable magnet mechanism 228 and/or the mounting block may be movably attached to the workpiece support table 214 by means of a hinge, a track, a slot, etc., to freely permit the switchable magnet mechanism 228 to move radially, both toward and away from the tool base 212, while substantially preventing lateral movement relative to the workpiece support table 214.

As seen in the phantom view shown in FIG. 2c, the switchable magnet mechanism 228 is mounted to the workpiece support table 214 by means of a track 221. The track 221 is configured to receive the switchable magnet mechanism 228 such that the switchable magnet mechanism 228 may slide both toward the tool base 212 and away from the tool base 212 toward a rear track wall 223. An arrow 233 represents the direction of movement of the switchable magnet mechanism 228. As the switchable magnet mechanism 228 moves in the track 221, the knob 232 also moves with the switchable magnet mechanism 228. Alternatively, a separate spline gear (not shown) may be provided to keep the position of the knob 232 fixed relative to the workpiece support table 214. The track 221 is also sized to substantially prevent lateral movement of the switchable magnet mechanism 228 relative to the workpiece support table 214. The track 221 and/or the switchable magnet mechanism 228 may also include other suitable means to prevent lateral movement, such as a series of ribs or protrusions (not shown). A spring 225 is also provided to bias the switchable magnet mechanism 228 away from the tool base 212. Thus, when the switchable magnet mechanism 228 is turned off, the spring 225 moves the switchable magnet mechanism 228 out of engagement with the tool base 212, thereby avoiding interference between the switchable magnet mechanism 228 and the tool base 212 while a user is positioning the workpiece support table 214.

Referring again to FIG. 2, it should be appreciated that the switchable magnet mechanism 228 may be mounted to the workpiece support table 214 in locations other than that shown in FIG. 2. Preferably, the switchable magnet mechanism 228 should be positioned such that it engages the tool base 212 near the outer edge of the tool base 212. As referred to herein, the outer edge of the tool base 212 should be understood to include any surface near the perimeter of the tool base 212. For example, rather than the switchable magnet mechanism 228 engaging the vertical surface 238 of the tool base 212, as shown in FIG. 2, the switchable magnet mechanism 228 could alternatively be positioned such that it engages the horizontal surface 240 of the tool base 212. Similarly, the switchable magnet mechanism 228 could be configured to engage both the vertical surface 238 and the horizontal surface 240 of the tool base 212. However, in the context of a miter saw 210, or any other rotatably positionable tool, it should be apparent that the switchable magnet mechanism 228 would be most effective in preventing rotation of the workpiece support table 214 when the switchable magnet mechanism 228 is positioned furthest from the central axis (see FIG. 1).

The tool base 212 may also be fitted with a steel plate 242 on which the switchable magnet mechanism 228 may be affixed when the magnetic lock 226 is locked. As shown in the context of a miter saw 210, the steel plate 242 is contoured according to the radius of the tool base 212. However, in the context of other positionable tools, the steel plate 242 may be planer. The switchable magnet mechanism 228, and any additional surfaces extending therefrom, is also precisely contoured according to the contour of the tool base 212 or the steel plate 242, thereby increasing the surface area of frictional engagement with the tool base 212, and providing a larger braking surface 227. Alternatively, the switchable magnet mechanism 228 may be planar.

Furthermore, one or more of the tool base 212, the steel plate 242, or the switchable magnet mechanism 228 may be coated with a highly durable, weather resistant coating, such as Titanium Nitride, to prevent wear. In addition to improving the durability of the coated components, the coating serves to increase the coefficient of friction, and therefore the frictional resistance, between the switchable magnet mechanism 228 and the tool base 212. Additionally one or more strips or pads of a frictional material, such as rubber or Silicon, may be provided on the braking surface 227 of the switchable magnet mechanism 228 to improve the frictional resistance between the switchable magnet mechanism 228 and the tool base 212. In order to keep the frictional material level with the surface of the switchable magnet mechanism 228, one or more depressions may be machined in the switchable magnet mechanism 228 for retaining the frictional material.

The tool base 212 includes a series of detents 243 to provide the user with an index of cutting angles, or alternatively, as shown in FIG. 2d, an additional means of locking the position of the workpiece support table 214 when used in connection with a separate, conventional locking mechanism. FIG. 2d is a cutaway side view of a magnetic lock 226 incorporating a conventional locking mechanism, such as a pin and detent-type lock. The pin and detent-type lock generally includes an engagement pin 245 for engaging one of the series of detents 243 located on the tool base 212. The engagement pin 245 is retained in a slot 251 in the switchable magnet mechanism 228, and is urged in a direction toward the tool base 212 by a biasing means 249, such as a spring. In its natural state, the engagement pin 245 may protrude from the slot 251 in the switchable magnet mechanism 228. In operation, the pin and detent-type lock may be used as an additional means of locking the workpiece support table 214 if a detent 243 is present at the location on the tool base 212 where the user wishes to lock the position of the workpiece support table 214. If a detent 243 exists at such a location, when the switchable magnet mechanism 228 is turned on and engages the tool base 212, the engagement pin 245 extends into the detent 243 to provide an additional means of locking the position of the workpiece support table 214. If a detent 243 does not exist at the location the workpiece support table 214 is locked, when the switchable magnet mechanism 228 is turned on, the switchable magnet mechanism 228 and the engagement pin 245 engage the tool base 212, and the engagement pin 245 is pushed into the slot 251. Alternatively, a conventional locking mechanism may be connected to the workpiece support table 214 separate from the magnetic lock 226, for example, at a position adjacent the magnetic lock 226.

To use the magnetic lock 226, a user may begin with the switchable magnet mechanism 228 turned off. Advantageously, the user is capable of selecting arbitrary positions at which the workpiece support table 214 is lockable. After rotating the workpiece support table 214 to the desired position, the user could then use a micro adjustment lever (not shown), if provided, to make any precise adjustments. Once the workpiece support table 214 has been moved to the desired position, the user may lock the position of the workpiece support table 214 by rotating the knob 232 one-half a revolution, thereby also rotating the rotatable magnet in the switchable magnet mechanism 228. With rotation of the rotatable magnet, the switchable magnet mechanism 228 turns on and provides a magnetic attraction directly toward the tool base 212. If the switchable magnet mechanism 228 is fully disengaged with the tool base 212 in the unlocked state, depending on the means by which it is attached to the workpiece support table 214, the switchable magnet mechanism 228 will either move into engagement with the tool base 212 under the force of magnetic attraction, or the user will move the switchable magnet mechanism 228 into engagement.

As shown in FIG. 2, the switchable magnet mechanism 228 may be mounted to the workpiece support table 214 in a position such that a portion of the breaking surface 227 is engagable with a detent 243, while the remaining portion of the breaking surface 227 is engagable with the tool base 212. Preferably, the switchable magnet mechanism 228 is positioned so that only a small portion of the switchable magnet mechanism 228 is engagable with a detent 243. Alternatively, the switchable magnet mechanism 228 and the detent 243 may be sized or positioned such that the portion of the breaking surface 227 engagable with the detent 243 is minimal in comparison to the portion engagable with the tool base 212.

The magnetic force provided by the switchable magnet mechanism 228 operates to increase the normal force the tool base 212 applies against an engaged switchable magnet mechanism 228, thus increasing the frictional resistance between the tool base 212 and the breaking surface 227 of the switchable magnet mechanism 228. The increased friction between the tool base 212 and the switchable magnet mechanism 228 operates to resist movement of the switchable magnet mechanism 228 relative to the tool base 212. In turn, movement of the workpiece support table 214 is resisted because the switchable magnet mechanism 228 is mounted to the workpiece support table 214 by a means that substantially prevents lateral movement of the switchable magnet mechanism 228 relative to the workpiece support table 214. Furthermore, because the magnetic force acts to pull the switchable magnet mechanism 228 directly toward the adjacent tool base 212 without transferring any significant forces to the workpiece support table 214, deflection of the workpiece support table 214 is substantially avoided. Once the switchable magnet mechanism 228 is frictionally engaged under the force of the magnetic attraction, the user can perform the various cutting and other operations provided by the tool. A user may unlock the locking mechanism 226 by rotating the knob 232 one-half of a revolution to also rotate the rotatable magnet within the switchable magnet mechanism 228.

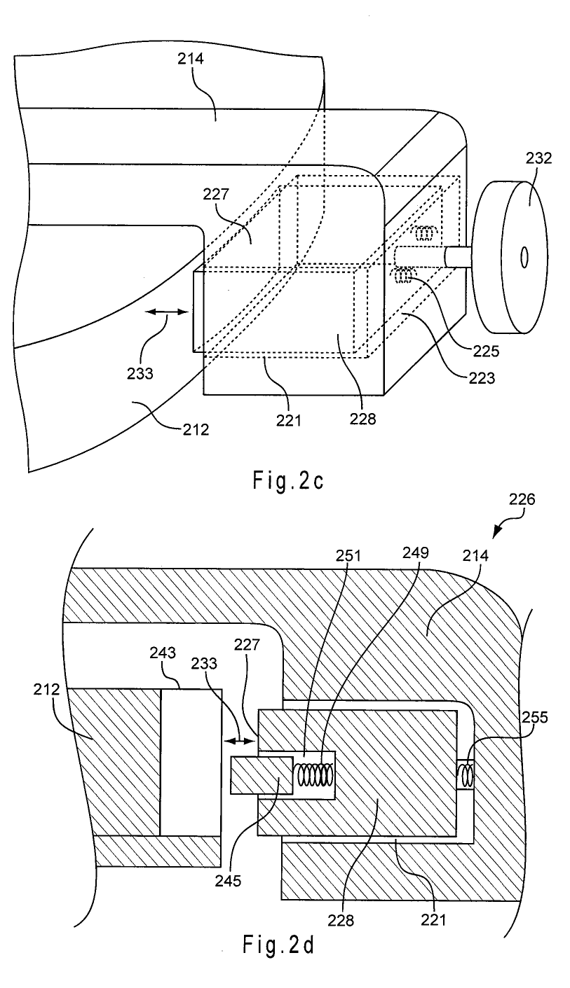

An alternative embodiment of a magnetic lock 326 is shown in FIG. 3. The magnetic lock 326 includes a switchable magnet mechanism 328, a mounting block 330, a lever 332, a shaft 333, and a grip 335. The switchable magnet mechanism 328 is fixedly mounted to the mounting block 330. As shown in FIG. 3, the mounting block 330 is hinged to the workpiece support table 314 about a pin 334. A hollow lever 332 extends from the mounting block 330 and encloses a shaft 333 operatively mounted to the rotatable magnet contained within the housing of the switchable magnet mechanism 328. A grip 335 is attached to the end of the shaft 333 to aid a user in rotating the shaft 331 and turning on or turning off the switchable magnet mechanism 328.

To use the magnetic lock 326, a user would begin with the switchable magnet mechanism 328 tuned off. When the switchable magnet mechanism 328 is turned off, the switchable magnet mechanism 328 and the hinged mounting block 330 are freely rotatable about the pin 334. By lifting upward on the lever 331 and/or the grip 335, a user may fully disengage the switchable magnet mechanism 328 from the tool base 312 as it rotates about the pin 334, away from the tool base 312. A releasable means for retaining the lever 331 in an upward position may also be provided. Alternatively, when turned off, the switchable magnet mechanism 328 may remain engaged in sliding contact with the tool base 312. At this point, a user can move the workpiece support table 314 to the desired position. To lock the position of the workpiece support table 314, a user would first rotate the switchable magnet mechanism 328 back into engagement with the tool base 312, if previously disengaged. The user would then turn on the switchable magnet mechanism 328 by rotating the shaft 333 using the grip 335. As the switchable magnet mechanism 328 is turned on, the switchable magnet mechanism 328 is attracted directly toward and firmly engages the tool base 312, thereby locking the position of the workpiece support table 314, without transferring to the workpiece support table 314 any significant loading forces. To unlock the magnetic lock 326, the user would use the grip 335 to rotate the shaft 333, and therefore the rotatable magnet within the switchable magnet mechanism 328, one-half of a revolution.

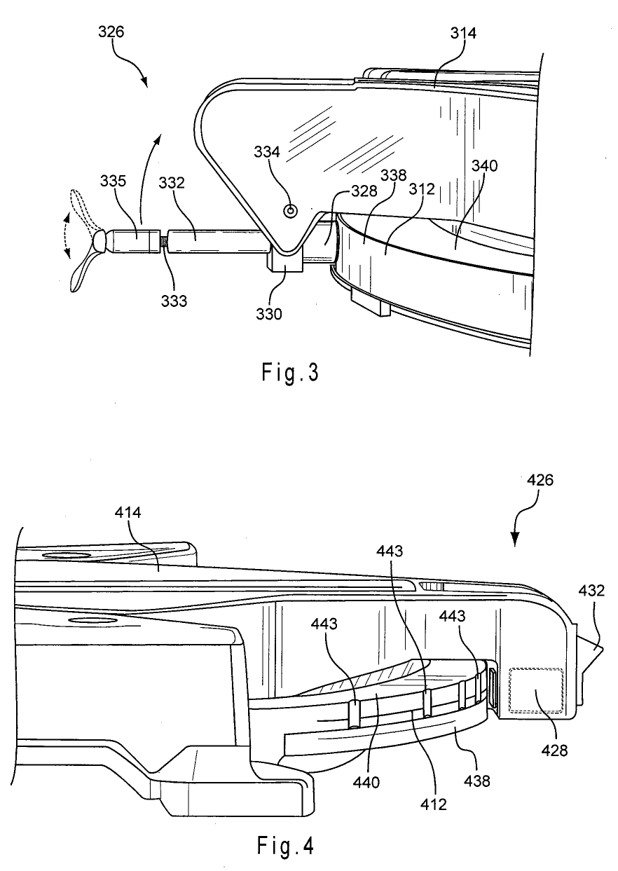

In a third embodiment, a magnetic lock 426 having an electromagnet 428 is provided. FIG. 4 shows a side view of the magnetic lock 426 incorporated into the miter saw 110 of FIG. 1. In general, the magnetic lock 426 includes an electromagnet 428 slidably mounted in a track, such as track 221 shown in FIG. 2c, and an electric switch 432 to control the delivery of an electric current to the electromagnet 428.

Briefly, electromagnets are devices that that allow a magnetic force to be generated and controlled by delivery of an electric current. Electromagnets generally comprise a segment of wire in the shape of a coil wrapped around a core of ferromagnetic or paramagnetic material. When an electric current flows through the wire, a magnetic field is generated around the wire and a magnetic force concentrates in the core. The strength of the magnetic force is dependent on the amount of current flowing through the wire and the number of turns in the coil. The magnetic force generated by the electromagnet permits the electromagnet to be affixed to a surface. The electromagnet 428 shown in FIG. 4 may be any commercially available electromagnet capable of providing a sufficient holding force and of suitable shape and size.

The primary difference between the structure, operation, and use of the magnetic lock 426 shown in FIG. 4 and the magnetic lock 226 shown in FIG. 2 is that the electromagnet 428 is turned on an off by operation of the electric switch 432, rather than rotation of a magnet, such as the one enclosed in the switchable magnet mechanism 228. Thus, when the magnetic lock 426 is unlocked, the electromagnet 428 is turned off, and the electromagnet 428 either remains in sliding contact with the tool base 412, or it may be disengaged from the tool base 412 under the influence of a biasing means, such as a spring, as explained above. When the magnetic lock 426 is locked, the electromagnet 428 is turned on and the electromagnet 428 firmly engages the tool base 412 under the force of magnetic attraction.

Like the switchable magnet mechanism 228, the electromagnet 428 is mounted to the workpiece support table 414 by any means which permit the electromagnet 428 to firmly engage the tool base 412 when the magnetic lock 426 is locked, and disengaged the tool base 412 when the magnetic lock 426 is unlocked. The electromagnet 428 should also be mounted to the workpiece support table 414 such that, when the magnetic lock 426 is locked, the electromagnet 428 does not transfer any significant loading forces to the workpiece support table 414. Accordingly, the electromagnet 428 may be mounted to the workpiece support table 414 by the same or similar means as those described above with respect to the switchable magnet mechanism 228. The electromagnet 428 may also be mounted to the workpiece support table 414 in any location that permits the electromagnet 428 to engage the outer edge of the tool base 412, including the vertical surface 438, as shown in FIG. 4, or alternatively, the horizontal surface 440, or both the vertical surface 438 and the horizontal surface 440.

To position a power tool using the magnetic lock 426, a user may begin with the electromagnet 428 turned off. As with the switchable magnet mechanism 228, the electromagnet 428 permits the user to select an arbitrary position at which the workpiece support table 414 may be locked. Once the user has moved the workpiece support table 414 to the desired location, the user may lock the position of the workpiece support table 414 with respect to the tool base 412 by activating the electric switch 432 and turning on the electromagnet 428. As the electromagnet 428 is turned on, the electromagnet 428 is attracted toward the tool base 412 under the force of magnetic attraction, the breaking surface of the electromagnet 428 firmly engages the tool base 412, and the frictional resistance between the electromagnet 428 and the tool base 412 is substantially increased. The magnetic lock 426 also avoids deflection because the electromagnet 428 is attracted directly toward and firmly engages the tool base 412 without transferring to the workpiece support table 414 any significant loading forces.

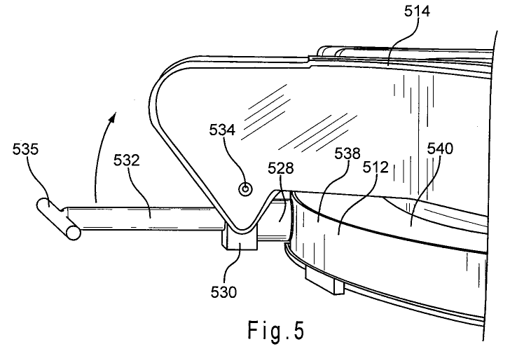

In a fourth embodiment, a magnetic lock 526 having a permanent magnet 528 is provided. FIG. 5 shows a side view of the magnetic lock 526 incorporated into the miter saw 110 of FIG. 1. In general, the magnetic lock 526 includes a permanent magnet 528, a mounting block 530 hinged about a pin 534, a lever 532, and a grip 535. The permanent magnet 528 may be any commercially available magnet providing a holding force sufficient to lock the position of a workpiece support table 514 with respect to a tool base 512. Preferably, the permanent magnet 528 is a type of rare earth magnet, such as Neodymium

The magnetic lock 526 differs from the embodiments shown in FIGS. 2 through 4 because the magnetic lock 536 utilizes a permanent magnet 528 producing a magnetic field continuous in time. As such, to unlock the position of the workpiece support table 514, the permanent magnet 528 must be fully disengaged with the tool base 512 in order to avoid the frictional resistance between the magnet 528 and the tool base 512. The permanent magnet 528 cannot remain in sliding contact with the tool base 512. When the magnetic lock 526 is locked, the permanent magnet 528 is firmly engaged with the tool base 512 under the force of magnetic attraction.

The permanent magnet 528 is attached to the workpiece support table 514 by any suitable means which permit the permanent magnet 528 to firmly engage the tool base 512 when the magnetic lock 526 is locked, and fully disengage the tool base 512 when the magnetic lock 526 is unlocked. In order for the magnetic lock 526 to remain selectively lockable, a user must be able to overcome the magnetic attraction between the permanent magnet 528 and the tool base 512. Accordingly, as shown in FIG. 5, a lever 532 is provided extending from the mounting block 530. The mounting block 530 is hinged to the workpiece support table 514 about a pin 534. The combination of the lever 532 and the hinged mounting block 536 aid the user with a mechanical advantage to overcome the magnetic attraction between the permanent magnet 528 and the tool base 512.

It should be appreciated that the permanent magnet 528, like the switchable magnet mechanism 228 and the electromagnet 428, may be mounted to the workpiece support table 514 such that the permanent magnet 528 engages the outer edge of the tool base 512 on the vertical surface 538, as shown in FIG. 5, or alternatively, the horizontal surface 540 of the tool base 512, or both the vertical surface 538 and the horizontal surface 540. Furthermore, the permanent magnet 528 may be attached to the workpiece support table by alternative means, such as those described above with respect to the switchable magnet mechanism 228.

To position a power tool using the magnetic lock 526, a user begins with the permanent magnet 528 engaged with the tool base 512. The user may unlock the magnetic lock 526 by pulling upward on the grip 535 and/or the lever 532 to overcome the magnetic attraction between the tool base 512 and the permanent magnet 528. As the user pulls the lever 532 upward, the mounting block 530 and the permanent magnet 528 rotate about the pin 534, the permanent magnet 528 disengages the tool base 512, and the workpiece support table 514 is permitted to move with respect to the tool base 512. A releasable means of retaining the lever 532 in an upward position may also be provided. Once the workpiece support table 514 is moved to the desired position, a user may lower the lever 532 until the permanent magnet 528 is firmly engaged with the tool base 512 under the force of magnetic attraction. Like the switchable magnet mechanism 228 and the electromagnet 428, the permanent magnet 528 substantially avoids deflection during the locking of the workpiece support table 514 because the permanent magnet 528 is attracted directly toward and firmly engages the tool base 512 without transferring to the workpiece support table 514 any significant loading forces.

Thus, the present invention provides a positionable power tool having an improved magnetic lock. The foregoing description of the invention has been presented for purposes of illustration and description, and is not intended to be exhaustive or to limit the invention to the precise form disclosed. It will be apparent to those skilled in the art that the present invention is susceptible of many variations and modifications coming within the scope of the following claims.

What is claimed is:

1. A magnetic lock for a positionable power tool of the type comprising a workpiece support table moveable relative to a tool base, the magnetic lock comprising:
a braking surface configured to contact an outer edge of the tool base; and,
a magnetic device mountable to the workpiece support table adjacent an outer edge of the tool base, the magnetic device being configured to provide a selectively variable force to push the braking surface against the outer edge of the tool base;
wherein the workpiece support table is substantially prevented from moving relative to the tool base when the braking surface is pushed against the outer edge of the tool base.

2. The magnetic lock of claim 1, wherein the magnetic device is a switchable magnet mechanism.

3. The magnetic lock of claim 1, wherein the magnetic device is an electromagnet.

4. The magnetic lock of claim 1, wherein the magnetic device is a permanent magnet.

5. The magnetic lock of claim 1, wherein the magnetic device is mountable to the workpiece support table in a track.

6. The magnetic lock of claim 1, wherein the magnetic device is mountable to the workpiece support table on a hinge.

7. The magnetic lock of claim 1, wherein the braking surface is contoured according to a contour of the tool base.

8. The magnetic lock of claim 1, wherein the braking surface further comprises an amount of frictional material.

9. The magnetic lock of claim 1, wherein the magnetic device further comprises a pin moveable relative to the magnetic device, the pin being configured to engage a detent provided on the tool base.

10. A positionable power tool having a magnetic lock comprising:
a tool base having an outer edge;
a workpiece support table rotatable relative to the tool base;
a braking surface configured to contact an outer edge of the tool base; and,
a magnetic device mounted to the workpiece support table adjacent the outer edge of the tool base, the magnetic device being configured to selectively increase a magnetic force to bias the magnetic device toward an engaged position, where the magnetic device pushes the braking surface against the outer edge of the tool base, so as to increase a frictional resistance between the braking surface and the tool base;
wherein the workpiece support table is substantially prevented from moving relative to the tool base when the frictional resistance is increased.

11. The positionable power tool of claim 10, wherein the magnetic device is a switchable magnet mechanism.

12. The positionable power tool of claim 10, wherein the magnetic device is an electromagnet.

13. The positionable power tool of claim 10, wherein the magnetic device is a permanent magnet.

14. The positionable power tool of claim 10, wherein the magnetic device is mounted to the workpiece support table in a track.

15. The positionable power tool of claim 10, wherein the magnetic device is mounted to the workpiece support table on a hinge.

16. The positionable power tool of claim 10, wherein the braking surface is contoured according to the contour of the outer edge of the tool base.

17. The positionable power tool of claim 10, wherein the braking surface further comprises an amount of frictional material.

18. The positionable power tool of claim 10, wherein the tool base further comprises at least one detent, and wherein the magnetic device further comprises a pin moveable relative to the magnetic device, the pin being engagable with the at least one detent.

19. A positionable power tool having a magnetic lock comprising:
a tool base;
a braking surface configured to contact the tool base;
a magnetic device configured to selectively increase a magnetic force; and,
a workpiece support table moveable relative to the tool base, the workpiece support table being configured to receive the magnetic device in a track, the magnetic device being moveable in the track between an engaged position and a disengaged position, where the magnetic device pushes the braking surface against the tool base when in the engaged position;
wherein the selectively increased magnetic force biases the magnetic device toward the engaged position; and,
wherein the workpiece support table is substantially prevented from moving relative to the tool base when the magnetic device is in the engaged position.

20. The positionable power tool of claim 19, wherein the magnetic device is a switchable magnet mechanism.

21. The positionable power tool of claim 19, wherein the magnetic device is an electromagnet.

22. The positionable power tool of claim 19, wherein the magnetic device is a permanent magnet.

23. The positionable power tool of claim 19, wherein the track is sized to allow the magnetic device to move relative to the workpiece support table in a direction of the magnetic force.

24. The positionable power tool of claim 19, wherein the track is sized to substantially prevent movement of the magnetic device relative to the workpiece support table in a direction perpendicular to the magnetic force.

25. The positionable power tool of claim 24, wherein a series of protrusions are provided on the magnetic device or on the track.

26. The positionable power tool of claim 19, wherein the tool base further comprises at least one detent, and wherein the magnetic device further comprises a pin moveable relative to the magnetic device, the pin being engagable with the at least one detent.

27. A positionable power tool having a magnetic lock comprising:
a tool base;
a workpiece support table moveable relative to the tool base;
a braking surface configured to contact the tool base; and,
a magnetic device configured to selectively increase a magnetic force, the magnetic device being mounted to the workpiece support table on a hinge, and the magnetic device being rotatable about the hinge between an engaged position and an disengaged position, where the magnetic device pushes the braking surface against the tool base in the engaged position;
wherein the selectively increased magnetic force biases the magnetic device toward the engaged position; and,
wherein the workpiece support table is substantially prevented from moving relative to the tool base when the magnetic device is in the engaged position.

28. The positionable power tool of claim 27, wherein the magnetic device is a switchable magnet mechanism.

29. The positionable power tool of claim 27, wherein the magnetic device is an electromagnet.

30. The positionable power tool of claim 27, wherein the magnetic device is a permanent magnet.

31. The positionable power tool of claim 27, wherein the tool base further comprises at least one detent, and wherein the magnetic device further comprises a pin moveable relative to the magnetic device, the pin being engagable with the at least one detent.

32. A method of magnetically locking a positionable power tool of the type having a workpiece support table moveable relative to a tool base, the method comprising:
providing a braking surface and a magnetic device, the magnetic device being mounted to the workpiece support table adjacent an outer edge of the tool base;
supplying a magnetic force to push the braking surface against the outer edge of the tool base, so as to increase a frictional resistance between the braking surface and the tool base.

33. The method of claim 32, wherein the magnetic device is a switchable magnet mechanism.

34. The method of claim 32, wherein the magnetic device is an electromagnet.

35. The method of claim 32, wherein the magnetic device is a permanent magnet.
